(19) United States
(12) Patent Application Publication
(10) Pub. No.: US 2024/0312674 A1
(43) Pub. Date: Sep. 19, 2024

(54) Cable and Cable Assembly

(71) Applicants: Tyco Electronics (Dongguan) Ltd., Dongguan City (CN); Tyco Electronics (Shanghai) Co., Ltd., Shanghai (CN)

(72) Inventors: Zhiwei (Jack) Guo, Dongguan (CN); Hainan (Harlan) Lu, Dongguan (CN); Zhi Chen, Dongguan (CN)

(73) Assignees: Tyco Electronics (Dongguan) Ltd., Dongguan City (CN); Tyco Electronics (Shanghai) Co., Ltd., Shanghai (CN)

(21) Appl. No.: 18/603,442

(22) Filed: Mar. 13, 2024

(30) Foreign Application Priority Data
Mar. 13, 2023 (CN) 202310238939.0

(51) Int. Cl. H01B 11/18; H01B 9/02; H01B 11/20

(52) U.S. Cl. CPC H01B 11/1843; H01B 9/028; H01B 11/1808; H01B 11/20

(57) ABSTRACT

A cable comprises at least two conductors, an inner insulating layer, a conductive shielding layer, and an outer insulating layer. The at least two conductors extend longitudinally and are spaced apart from each other. The inner insulating layer is wrapped around an outside of the at least two conductors and fixes their position. The conductive shielding layer is circumferentially wrapped around an outer peripheral surface of the inner insulating layer. The outer insulating layer includes a full-longitudinally wrapping structure attached onto an outer peripheral surface of the conductive shielding layer. The full-longitudinally wrapping structure is formed in a tubular shape circumferentially wrapped around an outside of the whole conductive shielding layer and extends continuously and longitudinally along the entire length of the cable.

### CROSS-REFERENCE TO RELATED APPLICATION

This application claims the priority benefit of Chinese Patent Application No. CN202310238939.0 filed on Mar. 13, 2023, in the China National Intellectual Property Administration, the whole disclosure of which is incorporated herein by reference.

### FIELD OF THE INVENTION

Embodiments of the present disclosure generally relate to a cable, and more particularly, to a cable capable of data transmission at a higher data transmission rate, and a cable assembly including the cable.

### BACKGROUND

A conventional structure of a data transmission cable mainly includes a pair of insulated conductors, a conductive shielding layer wrapping around the insulated conductors and a grounding wire, and an outer insulating layer wrapping around an outside of the conductive shielding layer. However, a high-frequency test bandwidth that the conventional structure can achieve is low, which cannot meet the requirements of higher-frequency data transmission, and the high-frequency performance is unstable.

Moreover, in conventional technologies, it is usually necessary to use a spirally wrapping process to wrap the outer insulating layer and/or the shielding layer on a turn-by-turn basis. The spirally wrapping structure causes significant echo loss, resulting in a high-frequency testing bandwidth of only about 40-60 GHz, which makes it difficult to achieve higher frequency bandwidth (such as the 112 GHz ultra-high frequency bandwidth required for 448G high-speed transmission); and when wrapping, the grounding wire will be taken away from a center, resulting in unstable structure of the cable and poor stability of the SI performance, and the quality of removing aluminum foil during assembly is affected, and burrs of the aluminum foil are easily generated, thereby adversely affecting the SI performance. And, the production efficiency of the wrapping process is low, and an ultra-high speed precision wrapping equipment is required, resulting in high production costs.

### SUMMARY

According to one embodiment of the present disclosure, a cable comprises at least two conductors, an inner insulating layer, a conductive shielding layer, and an outer insulating layer. The at least two conductors extend longitudinally and are spaced apart from each other. The inner insulating layer is wrapped around an outside of the at least two conductors and fixes their position. The conductive shielding layer is circumferentially wrapped around an outer peripheral surface of the inner insulating layer. The outer insulating layer includes a full-longitudinally wrapping structure attached onto an outer peripheral surface of the conductive shielding layer. The full-longitudinally wrapping structure is formed in a tubular shape circumferentially wrapped around an outside of the whole conductive shielding layer and extends continuously and longitudinally along the entire length of the cable.

### BRIEF DESCRIPTION OF THE DRAWINGS

The invention will now be described by way of example with reference to the accompanying Figures, of which:

FIG. 1 is a schematic radial cross-sectional view schematically showing a structure of a cable according to an exemplary embodiment of the present disclosure;

FIG. 2 is a schematic radial cross-sectional view schematically showing a structure of a cable according to another exemplary embodiment of the present disclosure;

FIG. 3 is a schematic radial cross-sectional view schematically illustrating a structure of a cable according to a further exemplary embodiment of the present disclosure; and

FIG. 4 is a schematic radial cross-sectional view schematically showing a structure of a cable assembly according to an exemplary embodiment of the present disclosure.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

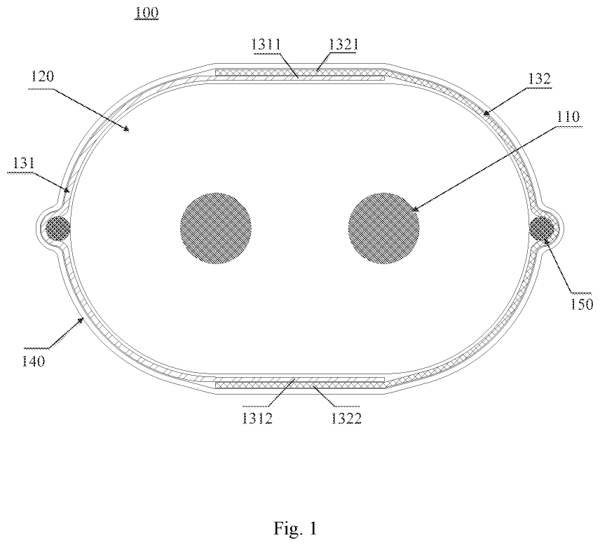

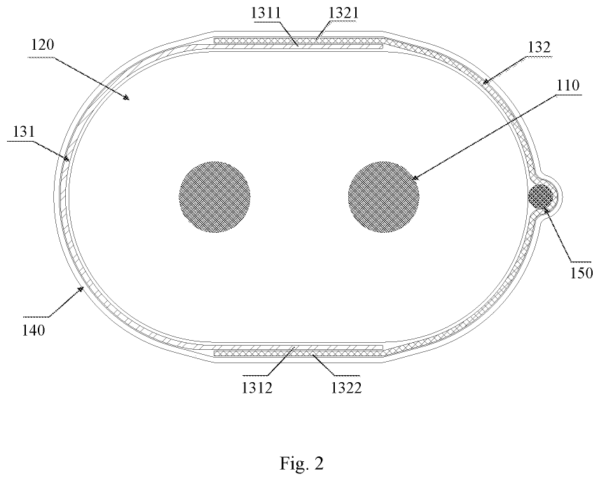

As shown in FIGS. 1-4, according to exemplary embodiments of the present disclosure, there is provided a cable 100, such as a twinaxial cable or a differential cable, capable of stable data transmission at higher transmission rates, such as at a frequency bandwidth of up to 112 GHz or higher, which at least meet the requirements of 448G (PAM4) high-speed transmission.

As shown, the cable according to the embodiments of the present disclosure includes at least two conductors 110 for transmitting signals or data, which are arranged to extend longitudinally or axially and be spaced apart from each other. As an example, the conductor may be made of a high-conductivity material such as a copper conductor, a silver-plated wire.

In the exemplary embodiments shown in FIGS. 1-4, the cable 100 further includes an inner insulating layer 120, a conductive shielding layer 130 and an outer insulating layer 140 which are sequentially arranged from inside to outside. The inner insulating layer 120 is wrapped around an outside of the at least two conductors 110 so as to fix positions of the at least two conductors 110. The conductive shielding layer 130 is circumferentially wrapped around an outside of the inner insulating layer 120 to provide signal shielding function for the cable. As an example, the inner or the outer insulating layer may be made of an insulating material such as polyester, polypropylene, polyethylene terephthalate (“PET” for short).

In a conventional cable, the insulating layer is wound around or bonded to the outside of each conductor to form an insulated core wire, and outer peripheries of the insulating layers of the adjacent insulated core wires are abutted against each other. There is a gap between the adjacent insulated core wires, which causes the cable structure to be easily deformed or the core wire to be easily displaced, thus the data transmission performance is unstable. Compared with the conventional cable, in some exemplary embodiments of the present disclosure, as shown in FIGS. 1-4, all conductors 110 of the same cable may be wrapped by a single inner insulating layer 120, the material of the inner insulating layer 120 is filled between the wrapped conductors, and the inner insulating layer 120 and all conductors 110 wrapped therein form a stable integrated structure, which can ensure that the conductors will not be displaced and the cable structure will not be deformed or less deformed in use, for example during use in a bent state, and the performance stability of the cable will be improved.

In some embodiments, the inner insulating layer 120 is a single extruded layer that wraps around all of the conductors 110 along a longitudinal or axial length of the at least two conductors 110. The inner insulating layer may be made of insulating polymer material. For example, the inner insulating layer may be formed over the at least two conductors 110 by a single extrusion step using an insulating material, such as polyolefin, polytetrafluoroethylene (PTFE), or polyethylene terephthalate (PET), in an extrusion process. The extruded layer is, for example, a continuous insulating layer extending axially or longitudinally over outer peripheral surfaces of the conductors. The extruded layer may be integrally and efficiently formed over the outer peripheral surfaces of the conductors by the extrusion process.

The conductive shielding layer 130 is wrapped around an outer peripheral surface of the inner insulating layer 120, and surrounds the outside of the inner insulating layer 120 in a longitudinal direction or along a longitudinal length of the inner insulating layer 120 to provide electromagnetic or signal shielding function for the conductors. The presence of the inner insulating layer may prevent the conductive shielding layer from entering a gap between the conductors.

In addition, in the conventional cable, an insulating tape or a Mylar sheet is usually wound (i.e., spirally wrapped) around the outside of the inner insulating layer in a longitudinal or axial direction of the cable on a turn-by-turn basis to form the outer insulating tape, the winding or spirally wrapping is time-consuming and inefficient, and there is a winding or wrapping pitch when using the insulating tape or the Mylar sheet, which may generate an echo loss, resulting in the high-frequency test bandwidth of only about 40-60 GHz for the conventional cable with this structure, and the performance of the cables is unstable.

However, according to the exemplary embodiments of the present disclosure, the outer insulating layer is changed from the previous spirally wrapping structure to the full-longitudinally wrapping structure, that is, the outer insulating layer 140 includes or forms as the full-longitudinally wrapping structure attached to the outer peripheral surface of the conductive shielding layer 130, the full-longitudinally wrapping structure being, for example, formed in a tubular shape circumferentially wrapped around the outside of the whole conductive shielding layer 130 and extending continuously and longitudinally along the entire length of the cable.

In other words, instead of the spirally wrapping arrangement of the outer insulting layer in the conventional cable, the exemplary embodiment of the present disclosure proposes an outer insulating layer with the full-longitudinally wrapping arrangement. The longitudinally wrapping arrangement eliminates the conventional spirally wrapping structure, so that the outer insulating layer could better fit over the internal structure, and the overall echo loss caused by the conventional spirally wrapping structure is eliminated, so that the frequency bandwidth of the cable may be easily increased from 60 GHz to 112 GHz or even higher, thereby being capable of meeting the requirements of high-speed data transmission, such as 448 Gbps.

As an example, a mold may be used to perform the fitting operation of the outer insulating layer with full-longitudinal wrapping arrangement. For example, when a wrapping material for the outer insulating layer are supplied into the mold, and while a semi-finished product of the cable (in which the conductor is already wrapped with the conductive shielding layer) travels longitudinally, the wrapping material of the outer insulating layer is fitted (e.g., bonded by hot melting or by an adhesive) over the inner-layer structure (e.g., the conductive shielding layer) using the mold. Removing the spirally wrapping structure may also eliminate the limitation of the production efficiency due to the wrapping speed of a spirally wrapping machine. For example, in one example, the production speed can be increased from 3 m/min to 20-50 m/min (for example, compared with a conventional 224 Gbps cable made with a 1.5 mm pitch and a wrapping speed of 2000 RMP/min). Removing the spirally wrapping structure can also remove the expensive spirally wrapping machine equipment, and instead, the longitudinally wrapping production using the mold could reduce equipment investment in the wrapping process by 99%. Thus, according to the exemplary embodiments of the present disclosure, the production efficiency of the cable can be significantly improved, the above-mentioned pitch can be eliminated, and the performance of the cable can be significantly improved, for example, the high-frequency test bandwidth of the cable can be increased to a higher frequency, such as 112 GHz or higher, so that the cable can be used as a cable suitable for data transmission at higher rates, such as 448 Gbps or higher.

As an example, the outer insulating layer may include a single layer of full-longitudinally wrapping structure, or two or more layers of full-longitudinally wrapping structure stacked on one another (e.g., arranged concentrically). Each layer of full-longitudinally wrapping structure may be attached to an outer peripheral surface of another layer of full-longitudinally wrapping structure or the conductive shielding layer located on an inner side of the layer of full-longitudinally wrapping structure in a radial direction by hot-melting or by an adhesive. For example, an adhesive layer, such as adhesive coating, adhesive, or hot melt adhesive, may be formed on the inner side or inner wall surface of each layer of full-longitudinally wrapping structure or the wrapping material of the outer insulating layer, so that each layer of full-longitudinally wrapping structure or the wrapping material could be better fitted over the inner structure by the mold.

In addition, in the conventional cable, the conductive shielding layer surrounds the inner insulating layer in the form of a complete loop or tape in a circumferential direction, and usually does not fit over the internal structure very well. In addition, an insulating tape or a Mylar sheet is conventionally wound on a turn-by-turn basis around an outside of the inner insulating layer in a longitudinal direction, the winding is time-consuming and inefficient, and there is a winding or wrapping pitch and an echo loss with the insulating tape or the Mylar sheet, thus, the high-frequency test bandwidth of the conventional cable with this structure can only reach about 40-60 GHz, and the performance of the cables is unstable.

However, according to an exemplary embodiment of the present disclosure, the conductive shielding layer includes two semi-longitudinally wrapping structures, each being circumferentially wrapped around a part of a circumference of the inner insulating layer and extending longitudinally, and the two semi-longitudinally wrapping structures are, for example, arranged to be diametrically opposed and combined to completely encircle the internal structure. In other words, Instead of the spirally wrapping arrangement of the conductive shielding layer in the conventional cable, the exemplary embodiment of the present disclosure proposes the conductive shielding layer with a semi-longitudinal wrapping arrangement, which includes two circumferential halves or semi-longitudinally wrapping structures wrapped around the internal structure (for example, the inner insulating layer, a grounding wire, etc.) in the circumferential direction, each circumferential half or semi-longitudinally wrapping structure being wrapped around at least half of the circumference of the corresponding internal structure in the longitudinal or axial direction of the cable. As an example, the circumferential half or semi-longitudinally wrapping structure of the conductive shielding layer may include a metallic shielding layer or tape.

The semi-longitudinal wrapping arrangement eliminates the conventional wrapping structure, so that the conductive shielding layer can better fit over the internal structure, thereby improving the stability of the SI performance of the cable, and the overall echo loss caused by the wrapping structure is further eliminated, so that the cable frequency bandwidth can be easily increased from 60 GHz to 112 GHz or even higher, thereby being capable of meeting the requirements of high-speed data transmission, such as 448 Gbps.

Similarly, a mold may be used to perform the fitting operation of the conductive shielding layer with semi-longitudinal wrapping arrangement, for example, a wrapping material for the conductive shielding layer is supplied into the mold, and while the semi-finished product (such as the conductor already wrapped with the inner insulating layer) travels longitudinally, the wrapping material of the conductive shielding layer is fitted (e.g., bonded by hot-melting or by an adhesive) over the inner structure (e.g., the inner insulating layer) using the mold. Removing the spirally wrapping structure may also eliminate the limitation of the production efficiency due to the wrapping speed of a spirally wrapping machine. For example, in one example, the production speed can be increased from 3 m/min to 20-50 m/min (for example, compared with a conventional 224 Gbps cable made with a 1.5 mm pitch and a wrapping speed of 2000 RMP/min). Removing the spirally wrapping structure can also remove the expensive spirally wrapping machine equipment, and instead, the longitudinally wrapping production using the mold could reduce equipment investment in the wrapping process by 99%. Thus, according to the exemplary embodiments of the present disclosure, the production efficiency of the cable can be significantly improved, the above-mentioned pitch can be eliminated, and the performance of the cable can be significantly improved, for example, the high-frequency test bandwidth of the cable can be increased to a higher frequency, such as 112 GHz or higher, so that the cable can be used as a cable suitable for data transmission at higher rates.

In the embodiments shown in FIGS. 1-4, the conductive shielding layer 130 includes a first semi-longitudinally wrapping structure 131 and a second semi-longitudinally wrapping structure 132, each being circumferentially wrapped around a part of the circumference of the inner insulating layer 120 and extending continuously and longitudinally along the entire length of the cable. Illustratively, each semi-longitudinally wrapping structure may be a continuous layer extending longitudinally along the entire length of the cable, or may include a plurality of longitudinal segments having a length significantly greater than the aforementioned pitch of the conventional cable. Each semi-longitudinally wrapping structure is attached to the outer peripheral surface of the inner insulating layer located on an inner side of the corresponding semi-longitudinally wrapping structure in the radial direction, for example, by hot-melting or by an adhesive.

As an example of the semi-longitudinally wrapping arrangement, the first semi-longitudinally wrapping structure 131 and the second semi-longitudinally wrapping 132 circumferentially each surround at least half of the circumference of the inner insulating layer 120 and are arranged to be diametrically opposed to each other, such as in the form of a roughly semi-ring facing each other, so that they are combined to circumferentially encircle the entire circumference of the inner insulating layer 120.

In the illustrated embodiment, two opposite circumferential end sections 1311, 1312 of the first semi-longitudinally wrapping structure 131 and two opposite circumferential end sections 1321, 1322 of the second semi-longitudinally wrapping structure 132 at least partially overlap with each other in the radial direction of the inner insulating layer 120 to form a closed loop circumferentially wrapping the inner insulating layer 120. For example, as shown in FIGS. 1-4, the circumferential end sections of the first semi-longitudinally wrapping structure 131 and the second semi-longitudinally wrapping structure 132 arranged to be diametrically opposed, partially overlap with each other at positions on two diametrically opposed sides of the inner insulating layer 120. Portions of the first semi-longitudinally wrapping structure 131 and the second semi-longitudinally wrapping structure 132 overlapping with each other may be flat portions (e.g., as shown in FIGS. 1-4), or may include a curved portion or an arc portion.

According to the embodiments of the present disclosure, the conductive shielding layer adopts the semi-longitudinally wrapping structure, which is fitted and installed by the mold, and the position where the two semi-longitudinally wrapping structures overlapping with each other is fixed, that is, the position is fixed with respect to a central axis of the cable in the circumferential direction, thus, burrs caused by unfixed or changing of the overlapping positions of the wrapping in the conventional cable can be avoided or eliminated when removing excess materials (e.g., removing aluminum foil by laser).

As shown in FIGS. 1, 2 and 4, the cable 100 may also include a separate grounding wire or drain wire, such as at least one grounding wire 150 provided between the conductive shielding layer 130 and the outer insulating layer 140. The grounding wire 150 can be in electrical contact with the conductive shielding layer 130, improving the electromagnetic shielding effect of the cable.

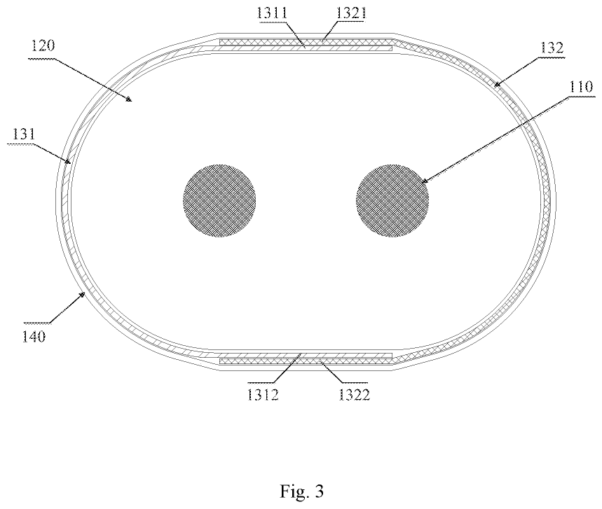

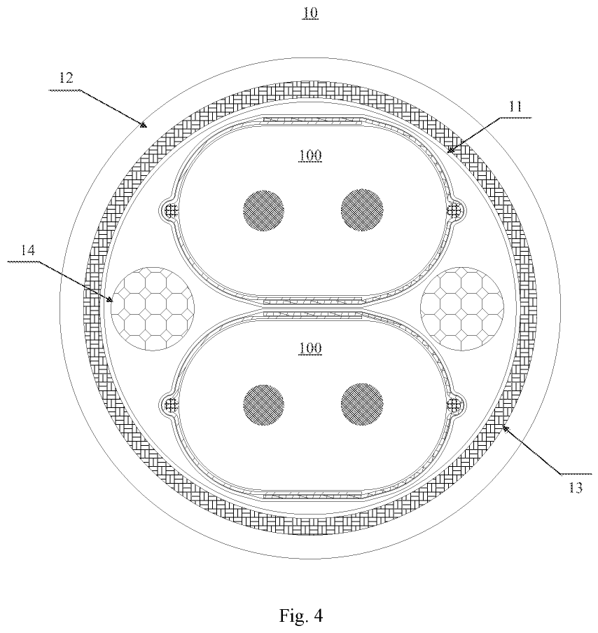

In the embodiments illustrated in FIGS. 1 and 4, two grounding wires 150 are provided, for example, provided on diametrically opposed sides of the inner insulating layer 120. In FIG. 3, only a single grounding wire 150 is provided on one side of the cable. The grounding wire 150 may be positioned between at least one semi-longitudinally wrapping structure of the first semi-longitudinally wrapping structure 131 and the second semi-longitudinally wrapping structure 132 and the inner insulating layer 120, and be in electrical contact with the at least one semi-longitudinally wrapping structure. For example, each grounding wire 150 may be positioned in a middle position of the first semi-longitudinally wrapping structure 131 or the second semi-longitudinally wrapping structure 132 in the circumferential direction, for example, within the same radial plane as the two central conductors 110.

According to the embodiments of the present disclosure, the wrapping structure is removed and the conductive shielding layer 130 adopts the semi-longitudinally wrapping structure, thus the position of the grounding wire of the cable may be fixed on its center line using the mold. For example, the grounding wire may be adhered to the inner wall surface of the semi-longitudinally wrapping structure by an adhesive layer, such as an adhesion coating, adhesive, or hot melt adhesive provided on the inner side or the inner wall surface of the semi-longitudinally wrapping structure. The conductive shielding layer in the form of the semi-longitudinally wrapping could better fit over and wrap the grounding wire. At least a part of the circumference of each grounding wire 150 may be wrapped by the corresponding semi-longitudinally wrapping structure and therefore stably fixed, thereby improving the offset of the grounding wire caused by the wrapping force of the wrapping tape in the wrapping structure. The grounding wire basically extends or is fixed in a straight line along the longitudinal or axial direction of the cable, that is, the position offset of the grounding wire within the longitudinal or length range of the cable is reduced or eliminated.

In other embodiments of the present disclosure, as shown in FIG. 3, the cable is not provided with any separate grounding wire, and instead, the conductive shielding layer 130 may be adapted to be electrically connected to an external ground and thus function as a grounding wire. For example, a conductive surface of the conductive shielding layer may face outward, that is, face the outer insulating layer, which facilitates the electrical connection between the conductive shielding layer and the external ground, and thereby better improving the shielding effect.

As an example of manufacturing the cable, the inner insulating layer is formed over the conductor (e.g., a single extruded layer is extruded over the conductor by a single extrusion step), and the first conductive or metal layer or tape with the semi-longitudinally wrapping arrangement is fitted over one side of the inner insulating layer using the mold so as to be used as the first semi-longitudinally wrapping structure of the conductive shielding layer, and then the second conductive or metal layer or tape with the semi-longitudinally wrapping arrangement is fitted over the other side of the inner insulating layer using the mold so as to be used as the second semi-longitudinally wrapping structure of the conductive shielding layer, such that the second conductive or metal layer or strip with the semi-longitudinally wrapping arrangement and the first conductive or metal layer or strip with the semi-longitudinally wrapping arrangement at least partially overlap with each other at the circumferential end sections (the overlapping positions between them are fixed relative to the central axis of the cable within the length range of the cable); and then, one or more insulating layers or strips with full-longitudinally wrapping arrangement are fitted over the outside of the first and second conductive or metal layers or strips by using the mold, so as to be used as the outer insulating layer; the inner sides of all layers or strips may have thereon hot melt adhesive, adhesive, or adhesive coatings, so that the corresponding strips or layers are bonded to the inner wire structure during each semi-longitudinally wrapping or full-longitudinally wrapping operation. In the case of setting the grounding wire, when the wrapping material for the conductive shielding layer is supplied into the mold, the grounding wire can be fixed on an inner side of the wrapping material in the mold, for example, fixed at the circumferential center position of the wrapping material by an adhesive layer, and then, while the semi-finished product of the cable (e.g., in which the conductor is already wrapped with the inner insulating layer) travels longitudinally, the wrapping material of the conductive shielding layer fixed with the grounding wire at the center on the inner side is fitted (e.g., bonded by hot melting or by an adhesive) over the inner structure (e.g., the inner insulating layer) by using the mold.

According to an embodiment of the present disclosure, there is also provided a cable assembly, as shown in FIG. 4, the cable assembly including at least two cables 100 described herein, which may be disposed within an outer sleeve 12. For example, these cables may be parallel, twisted or wound with respect to each other in the longitudinal direction. The number of cables of the cable assembly may be two or more, so that more signal, data or power transmission functions may be provided, and there is no signal interference between the cables.

The outer sleeve 12 can be in the form of a sheath, such as a metal tube or a plastic tube, to provide some protection. As shown, the cable assembly may also include a conductive shielding structure 11 provided within the outer sleeve 12, and the conductive shielding structure 11 may take the form of a layer/tape of metal or other conductive material and wrapped or wound around an outside of the all cables to provide further improved electromagnetic shielding effect.

In some examples, as shown in FIG. 4, the cable assembly may further include a braided layer 13 and/or an additional buffer layer provided in the outer sleeve 12, for example positioned between the conductive shielding structure 11 and the outer sleeve 12, to provide external force buffering or vibration damping function for the cables. In other examples, a space between the cables and/or a space between the cables and the buffer layer or the shielding structure may be further at least partially filled with a filler 14.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are

intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable, comprising:
at least two conductors arranged to extend longitudinally and spaced apart from each other;
an inner insulating layer wrapped around an outside of the at least two conductors and fixing the at least two conductors;
a conductive shielding layer circumferentially wrapped around an outer peripheral surface of the inner insulating layer; and
an outer insulating layer comprising a full-longitudinally wrapping structure attached onto an outer peripheral surface of the conductive shielding layer, the full-longitudinally wrapping structure being formed in a tubular shape circumferentially wrapped around an outside of the whole conductive shielding layer and extending continuously and longitudinally along the entire length of the cable.

2. The cable according to claim 1, wherein the outer insulating layer comprises a single layer of full-longitudinally wrapping structure or more layers of full-longitudinally wrapping structure stacked with respect to one another.

3. The cable according to claim 2, wherein each layer of full-longitudinally wrapping structure is attached to an outer peripheral surface of another layer of full-longitudinally wrapping structure or the conductive shielding layer located on an inner side of the layer of full-longitudinally wrapping structure in a radial direction by hot-melting or by an adhesive.

4. The cable according to claim 3, wherein an adhesive layer is provided on an inner wall surface of each layer of full-longitudinally wrapping structure.

5. The cable according to claim 1, wherein the conductive shielding layer comprises a first semi-longitudinally wrapping structure and a second semi-longitudinally wrapping structure, each of the first semi-longitudinally wrapping structure and the second semi-longitudinally wrapping structure circumferentially surrounding a part of a circumference of the inner insulating layer and extending continuously and longitudinally along the entire length of the cable.

6. The cable according to claim 5, wherein each of the first semi-longitudinally wrapping structure and the second semi-longitudinally wrapping structure circumferentially surrounds at least half of the circumference of the inner insulating layer, such that the first semi-longitudinally wrapping structure and the second semi-longitudinally wrapping structure, which are arranged to be diametrically opposed to each other, together circumferentially surround the entire circumference of the inner insulating layer.

7. The cable according to claim 6, wherein circumferential end sections of the first semi-longitudinally wrapping structure and the second semi-longitudinally wrapping structure arranged to be diametrically opposed, at least partially overlap with each other in a radial direction of the inner insulating layer to form a closed loop wrapped circumferentially around the inner insulating layer.

8. The cable according to claim 7, wherein the circumferential end sections of the first semi-longitudinally wrapping structure and the second semi-longitudinally wrapping structure arranged to be diametrically opposed, partially overlap with each other at positions on two diametrically opposed sides of the inner insulating layer.

9. The cable according to claim 8, wherein portions of the first semi-longitudinally wrapping structure and the second semi-longitudinally wrapping structure overlapping with each other comprise a flat portion or a curved portion.

10. The cable according to claim 8, wherein a position of the overlapping portion of the first semi-longitudinally wrapping structure and the second semi-longitudinally wrapping structure is fixed relative to a central axis of the cable in a circumferential direction.

11. The cable according to claim 6, wherein each of the first semi-longitudinally wrapping structure and the second semi-longitudinally wrapping structure is attached to the outer peripheral surface of the inner insulating layer located on an inner side of the corresponding semi-longitudinally wrapping structure in the radial direction by hot-melting or by an adhesive.

12. The cable according to claim 1, wherein the conductive shielding layer is adapted to be electrically connected to an external ground.

13. The cable according to claim 6, wherein the cable further comprises at least one grounding wire, which is arranged between the conductive shielding layer and the inner insulating layer and in electrical contact with the conductive shielding layer.

14. The cable according to claim 13, wherein the at least one grounding wire comprises a grounding wire, which is positioned between at least one semi-longitudinally wrapping structure of the first semi-longitudinally wrapping structure and the second semi-longitudinally wrapping structure and the inner insulating layer and in electrical contact with the at least one semi-longitudinally wrapping structure.

15. The cable according to claim 14, wherein the grounding wire is attached to a middle position of the at least one semi-longitudinally wrapping structure in a circumferential direction by the adhesive layer provided on the inner wall surface of the at least one semi-longitudinally wrapping structure.

16. The cable according to claim 1, wherein the inner insulating layer is a single extruded layer wrapping around the at least two conductors along a longitudinal length of the at least two conductors.

17. The cable according to claim 5, wherein the inner insulating layer is a single extruded layer wrapping around the at least two conductors along a longitudinal length of the at least two conductors.

18. The cable according to claim 7, wherein the inner insulating layer is a single extruded layer wrapping around the at least two conductors along a longitudinal length of the at least two conductors.

19. A cable assembly, comprising:
at least two cables, each cable including:
at least two conductors arranged to extend longitudinally and be spaced apart from each other;
an inner insulating layer wrapped around an outside of the at least two conductors so as to fix the at least two conductors;
a conductive shielding layer circumferentially wrapped around an outer peripheral surface of the inner insulating layer; and
an outer insulating layer comprising a full-longitudinally wrapping structure attached onto an outer peripheral surface of the conductive shielding layer, the full-longitudinally wrapping structure being formed in a tubular shape circumferentially wrapped around an outside of the whole conductive shielding layer and extending continuously and longitudinally along the entire length of the cable; and
a conductive shielding structure wrapped around an outside of the at least two cables; and an outer sleeve sleeved on an outer peripheral surface of the conductive shielding structure.

20. The cable assembly according to claim 19, further comprising at least one of a buffer layer or a filler provided between the at least two cables and the conductive shielding structure.
